(19) United States
(12) Patent Application Publication
(10) Pub. No.: US 2005/0207155 A1
(43) Pub. Date: Sep. 22, 2005

(54) Decorative candle

(76) Inventor: Chi-Sik Jian, Seoul (KR)

Correspondence Address: CHARLES E. BAXLEY, ESQ., 90 JOHN STREET, THIRD FLOOR, NEW YORK, NY, 10038, US

(21) Appl. No.: 11/024,155

(22) Filed: Dec. 27, 2004

(30) Foreign Application Priority Data
Nov. 19, 2003 (CN) 2003201270594

(51) Int. Cl. F21V 33/00

(52) U.S. Cl. 362/234; 362/86; 362/96; 362/390

(57) ABSTRACT

A candle set providing visual and audio effects with burning candles for celebration depending on the occasion includes holder, pistil barrel, powder barrel, spring, pull cord, multiple supports each in the form of a petal, rotation device, candle, and music IC control circuit; the support being hinged to the bottom of the pistil barrel; the powder barrel being placed in the pistil barrel; the candle being disposed at the distal end of the support; the rotation device includes upper cover, lower cover, torsion coil and turntable; a circular slot on the upper cover being filled up with viscose material to slow down and maintain consistent rotation; light emitting, music disconnection, and ignition devices.

### BACKGROUND OF THE INVENTION

1. (a) Field of the Invention

The present invention is related to a candle set for the occasion of birthday or festival, and more particularly, to a combined candle adapted with design of multiple foldable petals.

2. (b) Description of the Prior Art

In a celebration occasion including birthday, festival, wedding ceremony or party, cake decorated with multiple candles is almost a must. At first, candles are forthwith placed on the case and lighted one by one. However, the candle while allowing advantages of simple process and lower cost emits light only without music, dynamic sensation or fun. Furthermore, placement of the candles into the cake not only ruins the design of the dressing on the cake but also presents health problem. Therefore, a patented invention #002082411 teaches a swivel candle base for birthday cake. The prior art is essentially comprised of a post mounted with a plate in shape of multiple lotus leaves. A pistil is mounted at the center of the plate. A compression spring is disposed outside the pistil shank. A pistil cover and a barrel containing powder and adapted with a lid at top are connected to the pistil. Multiple petals are mounted externally to the pistil. A candle in bead shape is each mounted on the inner wall inside the head of the petal. A fixed pull cord connects between the powder barrel and the base of the plate. Two catches are respectively mounted on the outer walls of a torque box disposed at the base of the plate and the shank of the pistil. A guide ring is disposed in the post in conjunction with the catches. Once the powder is ignited to burn out the fixed pull cord thus to elevate the pistil while those multiple petals spread out together with the candles and start to rotate. However, the prior art is found with flaws that is rotates too fast and too soon, and failure in delivering the figure of the anniversary of the birthday as the case may be.

### SUMMARY OF THE INVENTION

The primary purpose of the present invention is to provide a combined candle set that rotates at slow and consistent speed.

Another purpose of the present invention is to provide a combined candle set that emits light and changed colors or wording of congratulations depending on the occasion.

Another purpose yet of the present invention is to provide a combined candle set that is provided with safety ignition device in achieving safe, convenient, beautiful and fun purposes.

Another purpose yet of the present invention is to provide a combined candle set that contains a music circuit adapted with a close device.

To achieve these purposes, a music and light emission combined rotation candle of the present invention is essentially comprised of holder, pistil barrel, powder barrel placed in the center of the pistil barrel, spring, pull cord, support in petal form being hinged to the bottom of the pistil barrel with candle disposed on the distal end of each support, rotation device, candle, and IC controlled music circuit. The rotation device includes an upper cover, a lower cover, a torsion coil, and a turntable. Both of the upper and the lower covers are fixed to each other to contain the turntable and a post extending downwardly from the center of the turntable. An opening is disposed on the post to secure the inner end of the torsion coil while the external end of the torsion coil is fixed to a fixation post protruding from the edge of the lower cover. Both of the upper cover and the turntable are each provided with two fixation holes for the pull cord, which penetrates the powder barrel, the spring, the upper cover and the turntable before being pulled tightly. A protruded ring is provided on the turntable and a circular slot filled up with viscose material is disposed on the inner side of the upper cover so to allow the protruded ring to rotate within the circular slot.

The upper cover and the turntable of the rotation device as well as the inner wall of an axial hole on the lower cover are also coated with the viscose material.

The support for the petal is made in two layers.

A through hole is disposed on the peripheral of the pistil on the pistil barrel.

One or multiple light emitting stick connected to the control circuit is disposed on the through hole. The top of the light emitting stick is disposed with a LED, and the LED in turn is inserted to a figure or letter through a connection sleeve. Two light emitting sticks are preferred.

A ignition device comprised of a flam stick inserted into the center of the powder barrel is disposed to the candle. The flame stick is comprised of an insertion rod and flame powder layer with the latter coated over the upper portion of the insertion rod.

An insulation copper wire is connected to the music control circuit to serve as the on/off control for the circuit. The insulation copper wire is fixed with a metal ring and wrapped around the surface of the powder barrel.

The present invention provides the following advantages and results:
1. The present invention provides a solution for the rotation of the combined candle. With the powder barrel ignited, the pull cord is burnt out while candles on the supports are also lighted. Both of the spring and the torsion coil are released to elevate the pistil and the support. Multiple supports each in the form of a petal carrying a candle spread up. The wound up torsion coil drives those petals, candles, and the pistil to rotate. The rotation maintains consistent and at lower speed for being subject to the viscose material coated in the circular slot.
2. The present invention creates excellent atmosphere with great visual and audio excitements when the flame conducts the control circuit to release the music, the LED controlled in the light emitting sticks by the control circuit flashes to highlight the figure or letters disposed at the top of the pistil as desired in a dazzling and colorful situation.
3. The present invention provides easy operation and convenient use to stop the music simply by pinching the metal piece to yank and break up the copper wire since the metal ring is provided on the insulation copper wire.
4. By using the ignition device, the flame stick inserted into the powder barrel in the candle is ignited to release beautiful firework, and later the flame is ejected when the burning of the flame stick reaches inside the powder barrel while other functions of the candle are triggered off. With the ignition method disclosed by the present invention, the combined candle presents in sequence and in tempo diversified effects to further improve the visual effects while the ignition device offers safe, eye-catching and easy operation.

### BRIEF DESCRIPTION OF THE DRAWINGS

FIG. 1 is an exploded view of a preferred embodiment of the present invention.

FIG. 2 is a perspective view of the preferred embodiment of the present invention as assembled.

FIG. 3 is an exploded view of a rotation device used in the present invention.

FIG. 4 is a schematic view showing a construction of another preferred embodiment of the present invention.

FIG. 5 is an exploded view of a light emitting structure used in the present invention.

FIG. 6 is a schematic view showing a structure of a device to close the music used in the present invention.

FIG. 7 is a schematic view showing a structure of an ignition device used in the present invention.

FIG. 8 is a schematic view showing a construction of another preferred embodiment yet of the present invention.

FIG. 9 is a sectional view showing that the present invention is in its closed status.

FIG. 10 is a sectional view showing that the present invention is in its unfolded status.

### DETAILED DESCRIPTION OF THE PREFERRED EMBODIMENTS

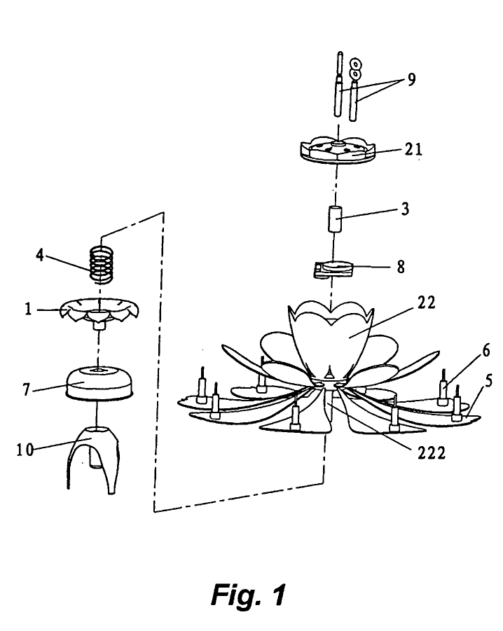

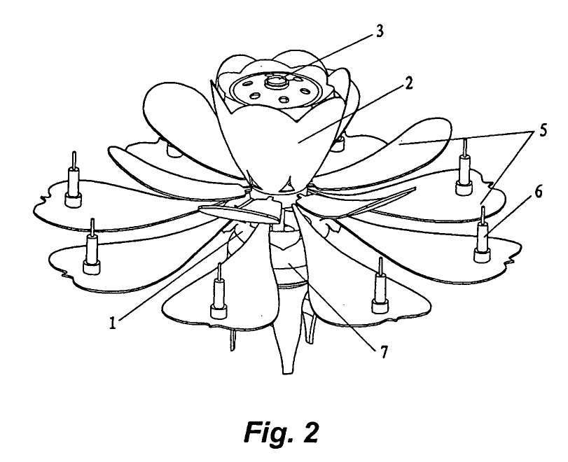

Referring to FIGS. 1 and 2, a preferred embodiment of the present invention includes a holder 1, a pistil barrel 2, a powder barrel 3, a spring 4, a pull cord (not illustrated), multiple supports 5 each in the shape of a petal, multiple candles 6, a rotation device 7, and a control circuit 8. The pistil barrel 2 includes a pistil 21 and the barrel 22. The pistil is locked to the top of the barrel 22 and the powder barrel is disposed in the center of the pistil 21. The pistil barrel 22 has on the peripheral at its bottom disposed with a slot to lock up the supports. A shank 222 is disposed at the center on the bottom of the pistil barrel 22.

The holder 1 relates to a support tray with edge extending outwardly and downwardly in arc. The spring 4 is inserted to the lower end of the shank 222 and penetrating through the holder 1, the rotation device 7 in order before being finally secured in a tripod 10. A total fourteen supports 5 provided in two layers with six on the inner layer and eight on the outer layer each in a shape of a petal are disposed on the peripheral to the pistil barrel 2. The proximate end of the support 5 to the pistil barrel 22 is locked into the locking slot at the bottom of the pistil barrel. The small color candle 6 is fixed to the distal end of each support 5. The control circuit 8 is placed in the pistil barrel 2. An opening is disposed to the powder barrel 3 at where appropriately to admit the entrance of the pull cord to travel down for pulling tight both of the spring 4 and the rotation device 7.

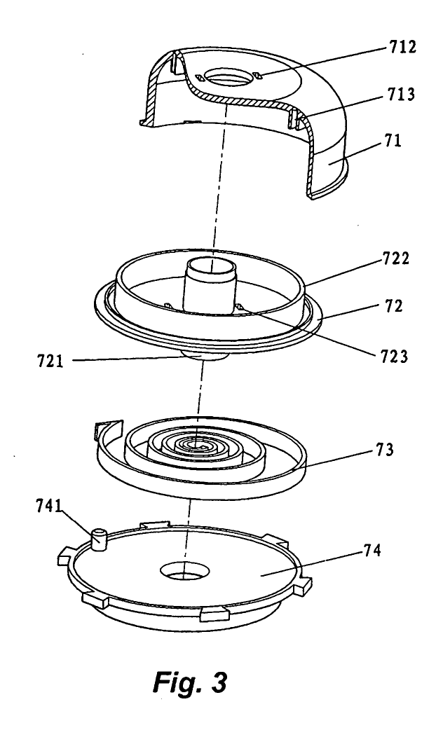

Now referring to FIG. 3, the rotation device 7 is comprised of an upper cover 71, a turntable 72, a torsion coil 73, and a lower cover 74. Wherein, both of the upper cover 71 and the lower cover 74 are fixed to each other either by insertion or by engagement of the spacing between the inner and the outer surface of each of the upper and the lower covers 71, 74 to contain the turntable 72. A protruded post 721 extends downwardly from the center of the turntable 72. An opening is disposed on the protruded post 721 to secure the inner end of the torsion coil 73. The outer end of the torsion coil is fixed to a fixation post 741 protruding from the edge of the lower cover 74. Both of the upper cover 71 and the turntable 72 are each disposed with two holes 712, 713 to secure the pull cord. The pull cord penetrates through the powder barrel 3, the spring 4, the upper cover 71 and the turntable 72 before being pulled tight. A protruded ring 722 is disposed on the turntable 72 and a corresponding circular slot 713 is provided on the inner side of the upper lid 71 to allow the protruded ring 722 to turn in the circular slot 713. The circular slot 713 is filled up with viscose material. The upper cover 71 in the preferred embodiment is connected to the lower cover 74 by insertion. Upon turning the lower cover 74, the torsion coil 73 drives the protruded ring 722 from the turntable 72 to turn in the circular slot 713 of the upper cover 71. As the outer end of the torsion coil 73 is fixed to the protruded post 741 on the surface of the lower cover 74, the upper cover 71 fixed to the lower cover 74 is also driven to turn at the same time. Both of the upper cover 71 and the lower cover 74 turn at a slow speed as restricted by the viscose material filled up in the circular slot 713.

The control circuit 8 includes a power source, a loudspeaker, an insulation copper wire, and music IC connected in a method well known to those who are familiar in this art. The music IC is pre-installed with birthday song or other song depending on the occasion of the festival.

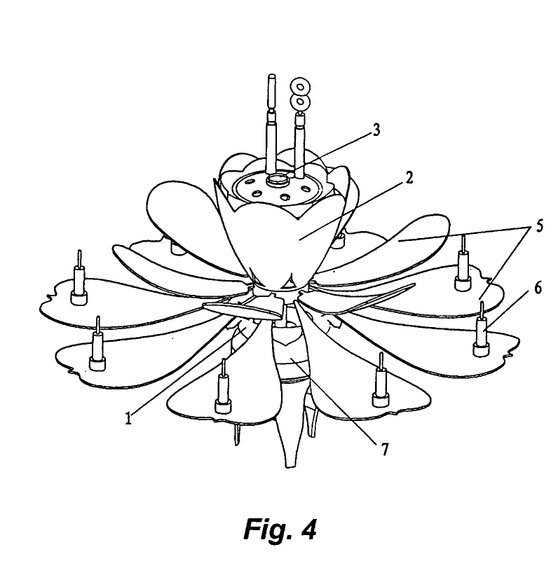

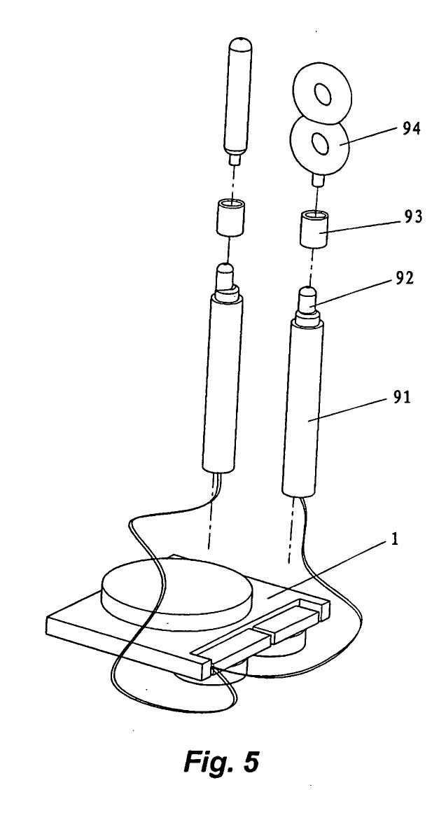

As illustrated in FIGS. 4 and 5 for another preferred embodiment of the present invention, two additional light emitting devices are provided to the pistil 21 on the basis of the first preferred embodiment described above. Both light emitting devices are connected in parallel with the control circuit. An LED 92 is disposed at the top of a light emitting stick 91, and both LEDs 92 are connected in parallel with the control circuit 8. The LED 92 may be set to continue to emit light or set for a given light emitting frequency. The LED 92 is connected to a FIG. 94 made of plastic material by means of a sleeve 93. The plastic FIG. 94 related to a number, letter, carved pattern, or the wording depending on the occasion such as Happy Xmas in solid form. Once the circuit is connected, the LED 92 emits the light according to its preset frequency through the plastic figure or letter 94.

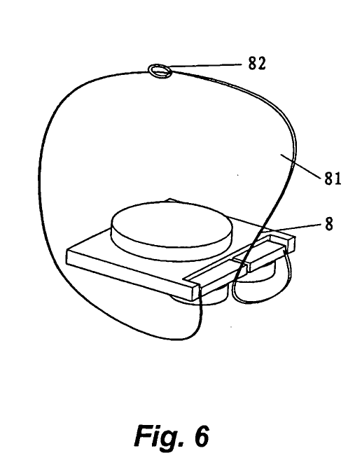

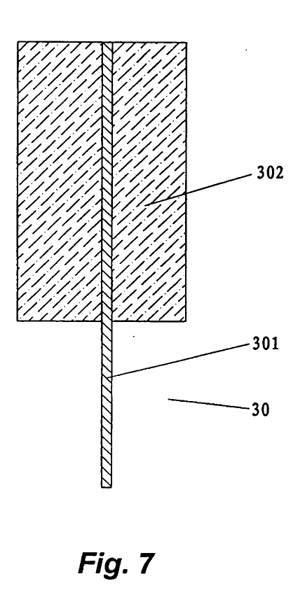

Now referring to FIG. 6, a music disconnection device is further adapted to the present invention. An insulation copper wire 81 serving an circuit ON/OFF is connected to the music control circuit 8. The insulation copper wire 81 penetrates through a metal ring 82. As illustrated in FIG. 7, the insulation copper wire 81 wraps around the powder barrel 3 and the metal ring 82 is located on the surface of the powder barrel 3. To disconnect the music, pinch with fingers the metal ring 82 to break up the insulation copper wire 81, or fetch for a pair of scissors to forthwith cut off the circuit.

To provide further visual effects, an ignition device is adapted to the present invention. The ignition for the combined candle as illustrated in FIG. 7 is done by igniting a fuse contained in the powder barrel 3, or by a burning mosquito incense or a cigarette. In the preferred embodiment, a flame stick 30 is inserted to the center of the powder barrel 3. The flame stick 30 is comprised of an insertion rod 301 and a flame powder layer 302 with the latter coated over the upper portion of the insertion rod 301. By igniting the flame stick 30, it release instantly beautiful firework, and the flame is further ejected once the burning flame stick 30 reaches inside the powder barrel 3 while triggering off other functions of the candle.

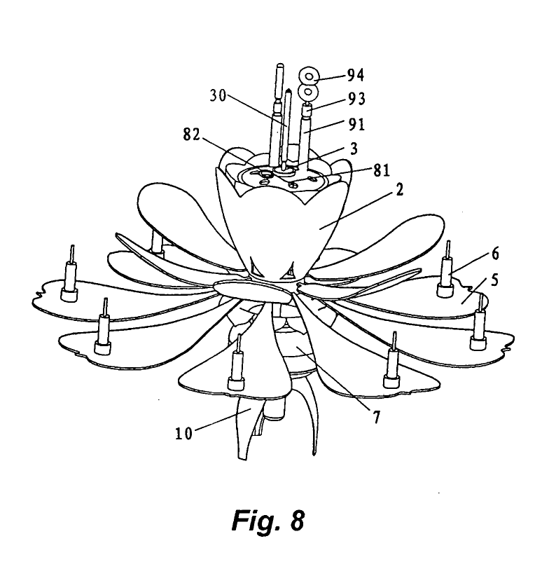

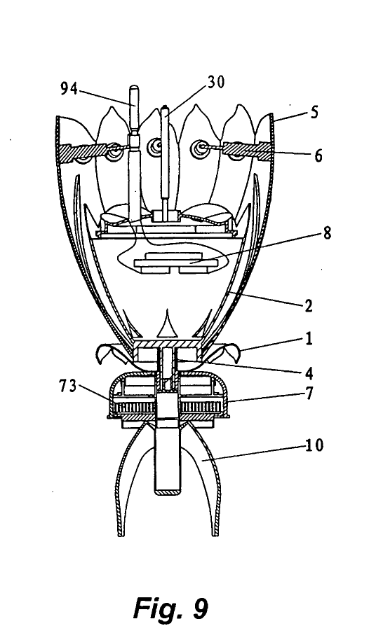

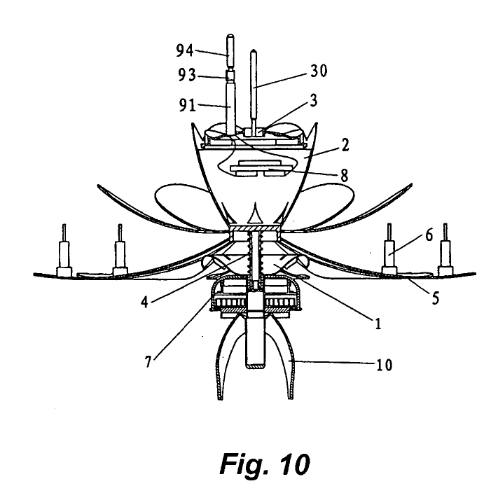

As illustrated in FIGS. 8, 9, and 10, the pull cord renders the spring 4 in a compressed status, and the support 5 for being subject to the push by the holder 1 folds in to wrap up around the pistil barrel 2. Once the flame stick 30 on the top of the powder barrel 3 is ignited, the candle 6 at the distal end of the support 5 is lighted. Sparks from the flame stick 30 further ignites the powder barrel 3 to burnt out the pull cord, thus to elevate the pistil barrel 2 when subject to the push by the spring 4. Meanwhile, all supports 5 are unfolded to spread up in a pattern of two layers of petals. The burnt out pull cord also releases the already wound up rotation device 7. Combustion triggered off by the sparks from the flame stick 30 also burns out the surface layer of the insulation copper wire to connect the power source to the music device, thus to play the music. LEDs 92 start to emit light to highlight the figure or the letter 94. The entire unit of the combined candle of the present invention therefore create flames, burning candles, flaring figure or letter, and music all in rotation at a constant and slow speed for the treat of a wonderful sight for the occasion.

1. A music and light emitting combined rotation candle includes base, pistil barrel, powder barrel, spring, pull cord, support in the form of a petal, rotation device, candle, and music IC control circuit; the support being hinged to the bottom of the pistil barrel, the powder barrel being placed in the pistil barrel; a candle is disposed on the distal end of the support, the rotation device including an upper cover, a lower cover, a torsion coil, and a turntable; both of the upper and the lower covers being fixed to each other; the turntable being placed in where between both of the upper and the lower covers; a protruded rod extending downwardly from the center of the turntable; an opening being disposed on the protruded post below the turntable; the inner end of the torsion coil being secured by the protruded post from the turntable; the outer end of the torsion coil being secured to a fixation post protruding from the edge of the lower cover; both of the upper cover and the turntable being respectively disposed with a pair of holes to secure the pull cord; the pull cord penetrating through the powder barrel, the spring, the upper cover and the turntable before being pulled tight; a protruding ring being provided on the turntable and a corresponding circular slot being disposed on the inner side of the upper cover; the protruded ring circulating within the circular slot; and the circular slot being filled up with a viscose material.

2. The music and light emitting combined rotation candle of claim 1, wherein the upper cover, the turntable and the inner wall of the axial hole of the lower cover are all coated with viscose materials.

3. The music and light emitting combined rotation candle of claim 1, wherein those multiple supports each in the form of a petal are arranged in two layers.

4. The music and light emitting combined rotation candle of claim 1, wherein a through hole is disposed on the peripheral of the pistil on the pistil barrel; one or multiple light emitting stick is provided on the through hole; an LED is disposed at the top of the light emitting stick; and the LED is connected to a figure or letter with a sleeve.

5. The music and light emitting combined rotation candle of claim 4, wherein two flame sticks are provided.

6. The music and light emitting combined rotation candle of claim 1 or 4, wherein an ignition device is provided to the candle; the ignition device related to a flame stick inserted into the center of the powder barrel; the flame stick is comprised of an insertion rod and a flame powder layer; and the flame powder layer is coated over the upper portion of the insertion rod.

7. The music and light emitting combined rotation candle of claim 6, wherein an insulation copper wire is connected to the music control circuit to serve as a On/Off control for the circuit; a metal ring is fixed to the insulation copper wire; and the insulation copper wire wraps around the surface of the powder barrel.
